(19) United States
(12) Patent Application Publication
(10) Pub. No.: US 2011/0252043 A1
(43) Pub. Date: Oct. 13, 2011

(54) ELECTRONIC COMMUNICATION CONTROL

(75) Inventor: Mark Crispin Webb-Johnson, Kowloon (CN)

(73) Assignee: NETWORK BOX CORPORATION LIMITED, Kowloon (HK)

(21) Appl. No.: 13/121,927

(22) PCT Filed: Oct. 1, 2009
(86) PCT No.: PCT/IB09/07012

§ 371 Date: Jun. 27, 2011

(30) Foreign Application Priority Data
Oct. 1, 2008 (AU) 2008905118

(51) Int. Cl. G06F 17/30

(52) U.S. Cl. 707/748; 707/803; 707/E17.005; 707/E17.044

(57) ABSTRACT

An electronic communication control system including a communication transfer component for temporarily storing at least part of an electronic communication from a sender to an intended recipient; a communication analyser associated with the communication transfer component for analysing the stored part of the electronic communication to determine at least two sender attributes of the sender and at least one intended recipient attribute of the intended recipient; a database for storing data records having a score and being associated with at least two sender attributes and an intended recipient attribute; and a database manager in communication with the communication analyser for creating a data record in the database associating the sender attributes with the intended recipient attribute and having a score based at least in part on information received from the message analyser.

### FIELD

The present invention relates to methods and systems for controlling electronic communications, for example electronic mail.

### BACKGROUND

The prevalence, speed and convenience of wired and wireless computer networks, and in particular the Internet, has resulted in increasing reliance on electronic forms of communication. The most common form of electronic communication is electronic mail (also referred to as “email”), but increasing use is made of other forms of electronic communication such as Short Messaging Service (SMS) and instant messaging (IM).

The low cost and widespread use of electronic communications has resulted in its increasing use as an advertising and defrauding mechanism. For example, electronic communications may be used to directly or indirectly (e.g. through an associated website) obtain sufficient details about a person to impersonate that person. This is commonly referred to as “identity theft”.

Unsolicited commercial email and SPAM are terms that have been coined to identify this class of unwanted and sometimes dangerous email. Unsolicited commercial instant messages are also a form of SPAM. A spammer can send emails or instant messages to thousands of recipients nearly instantaneously at little to no cost. A success rate of less than 1% would still make such mass communication worthwhile.

Unfortunately, the prevalence of SPAM results in users of communication networks receiving large numbers of unwanted messages. Manually separating the desired messages from the unwanted messages is time consuming and a waste of transmission and storage resources. Accordingly, automated mechanisms have been developed to separate the wanted messages from the unwanted messages.

Conventionally, messages have been classified as either SPAM or not SPAM, with SPAM messages either being deleted, blocked, or simply labelled as SPAM to allow email client filtering of such messages. Messages have been classified as SPAM based on the contents of the message and/or the identity of the sender of the message. Accordingly, messages with a sufficient number of blacklisted words, spelling mistakes or the like may be classed as SPAM. Similarly, messages originating from someone known to send SPAM may also be classified as SPAM. Unfortunately, such filtering mechanisms are prone to error. For example, an email containing a large number of spelling errors may not be SPAM, but instead may be a personal missive from a child. Filtering based on the sender's email address is unreliable as the email address may be forged, or ‘spoofed’.

Developing a system architecture and message processing to address this provides a significant technical challenge.

It is desired to address this or at least provide a useful alternative.

### SUMMARY

In accordance with the present invention there is provided an electronic communication control system including:
a communication transfer component for temporarily storing at least part of an electronic communication from a sender to an intended recipient;
a communication analyser associated with the communication transfer component for analysing the stored part of the electronic communication to determine at least two sender attributes of the sender and at least one intended recipient attribute of the intended recipient;
a database for storing data records having a score and being associated with at least two sender attributes and an intended recipient attribute; and
a database manager in communication with the communication analyser for creating a data record in the database associating the sender attributes with the intended recipient attribute and having a score based at least in part on information received from the message analyser.

The present invention also provides a method, performed by an electronic communication control system, including:
(a) parsing an electronic communication from a sender to an intended recipient;
(b) storing a primary attribute and at least one additional attribute associated with the sender, and a primary attribute associated with the intended recipient;
(c) generating a likelihood score, representing the estimated likelihood the electronic communication is unwanted by the intended recipient, using a stored data for electronic communications between at least one communication participant having the same primary and additional attributes as the sender and at least one other communication participant having the same primary attribute as the intended recipient; and
(d) processing said electronic communication based on said likelihood score.

The present invention also provides a method, performed by an electronic communication control system, including:
(a) extracting from an electronic communication sent by a sender to an intended recipient, primary attributes of the sender and recipient, and at least one additional attribute of the sender; and
(a) maintaining at least one data record having a score and associating the primary and additional attributes of the sender and the primary attribute of the intended recipient, said score representing a relationship between said sender and said recipient.

The present invention also provides an electronic communication control system including:
a communication analyser for analysing an electronic communication to determine a sender attribute and an intended recipient attribute; and
a relationship database for storing a data record having a relationship score associated with the sender attribute and the intended recipient attribute; and a processor in communication with the communication analyser and database for controlling whether the electronic communication is processed as unwanted by the intended recipient.

### DESCRIPTION OF DRAWINGS

Preferred embodiments of the present invention are hereinafter described, by way of example only, with reference to the accompanying drawings, wherein:

FIG. 1 is a block diagram of a preferred embodiment of an electronic communication control system in accordance with the present invention.

FIG. 2 is a flow diagram of a method for generating a likelihood score representing the estimated likelihood that an electronic communication from a sender to an intended recipient is unsolicited or unwanted by the intended recipient using the system of FIG. 1.

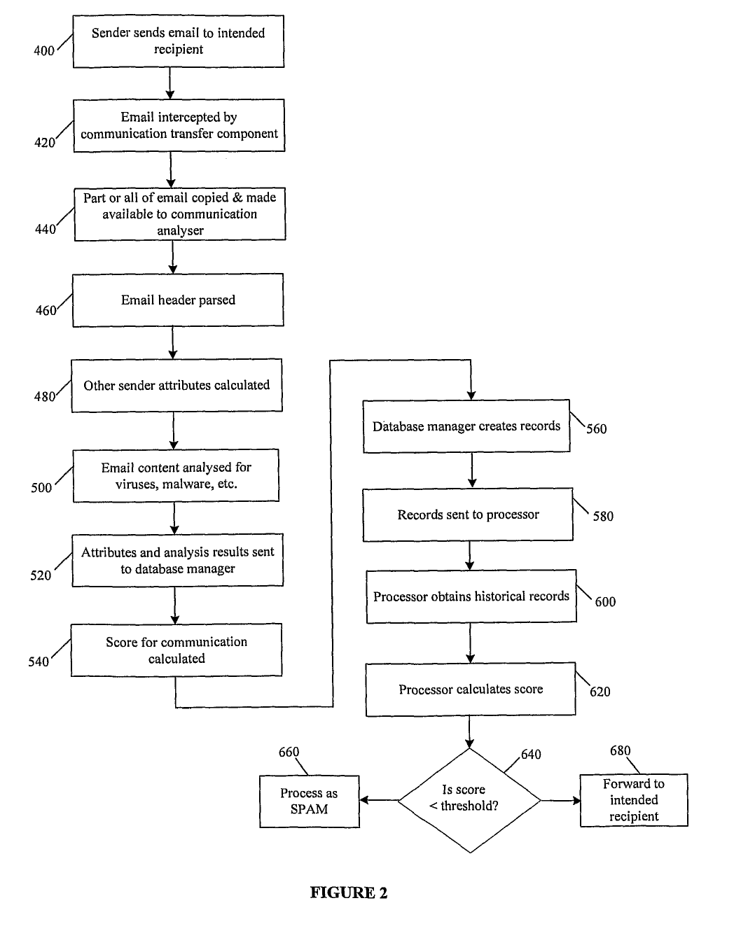

FIG. 3 is a block diagram of the system illustrated in FIG. 1 as part of a security server system connected to a local area network (LAN).

### DETAILED DESCRIPTION

An electronic communication control system 10 will now be described in the context of controlling email communication, although as indicated above, the invention may be equally applicable to other forms of electronic communication such as instant messaging and Short Messaging Service.

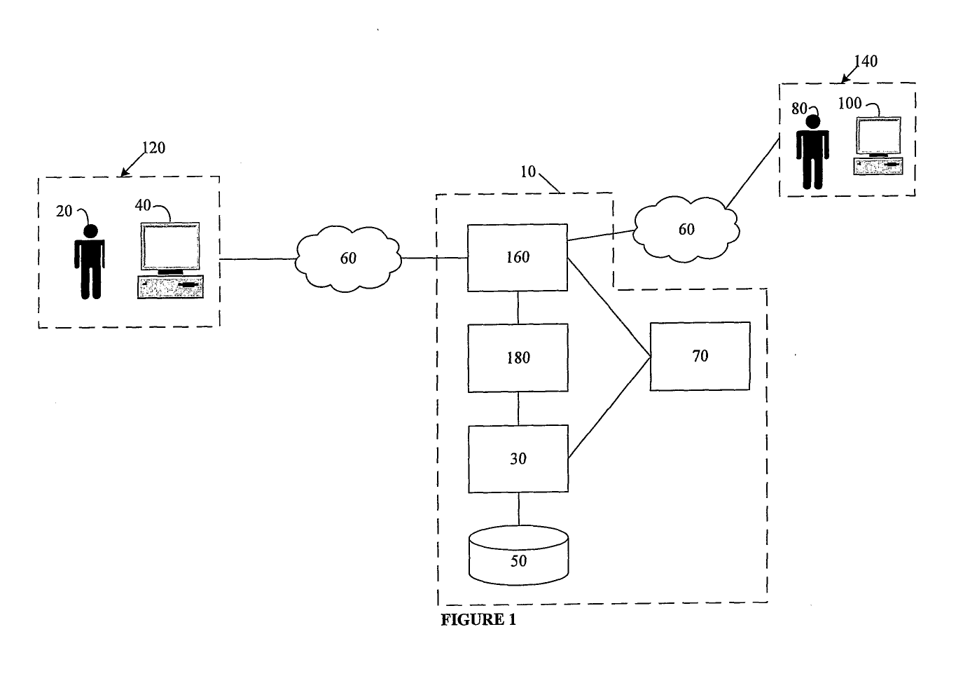

As illustrated in FIG. 1, a sending person 20 wishing to send an electronic communication uses a sending device 40 to generate and send the electronic communication using a communications network 60. The sending device 40 is typically a combination of hardware including a network interface device for interfacing with the communications network 60, and software executing on the hardware enabling the sending person 20 to compose and address the electronic communication to an intended recipient 140. Intended recipient 140 comprises person 80 and receiving device 100 connected to the communications network 60 to receive the communication. The sending person 20 and sending device 40 are together the sender 120, and the receiving person 80 and receiving device 100 are together the intended recipient 140.

The communications network 60 is configured so that electronic communications sent from the sender 120 and directed to the intended recipient 140 are sent to a communication transfer component 160. The communication may be intercepted at a number of points along the communication path, including at the sender's Internet Server Provider. In this preferred embodiment of the present invention, the communication transfer component 160 forms one of the interception points along the communications path. In effect, the communication transfer component 160 intercepts the electronic communications from the sender 120 to the intended recipient 140. Communication transfer component 160 may be part of a Local Area Network (LAN) proxy service, wherein sending device 40 is part of the LAN (as further described below). Alternatively, communication transfer component 160 may be part of an internet service provider's equipment, where all electronic communications involving some or all customers of the internet service provider pass through the communication transfer component 160.

The communication transfer component 160 temporarily stores at least part of a copy of the electronic communication sent by the sender 120 directed to the intended recipient 140. For example, it may temporarily store the header information if the communication is an email. Alternatively, it may store a complete copy of the electronic communication.

The communication transfer component is 160 associated with a communication analyser 180 for analysing the stored part of the electronic communication. The communication analyser 180 parses the stored part of the electronic communication to identify attributes of the sender 120 and/or receiver 140, and may use parsed information to calculate or derive attributes of the sender 120 and/or receiver 140.

Set out below is an example of an extract of an email header containing information about the sender 120, including the return-path (the sender's email address, set out in the last line of the extract) and the network address (in this case 216.241.145.38) and domain name (in this case omta0101mta.everybody.net) of the mail exchange server of the sender 120, both found in the second line of the extract below. The extract of the email header also contains the network address of the sending device 40 (in this case 172.16.1.96, found on the fourth line of the extract) and the communications address of the sender in the form of the sender's email address (in this case joe.bloggs@domain1.com).

```
Microsoft Mail Internet Headers Version 2.0
Received from imta-38.everybody.net (HELO omta0101.mta.everybody.net) (216.241.145.38)
  by communication.transfer.com with SMTP; 30 Aug 2010 08:11:58 -0000
Received: from dm23.mta.everybody.net (sj1 -slv03-gw5 [172.16.1.96])
    by omta0101.mta.everybody.net (Postfix) with ESMTP id 538DD7C37E5
    for <jane.doe@domain2.com>; Wed, 30 Aug 2010 01:11:55 -0700 (PDT)
Received: by resin11.mta.everybody.net (EON-PICKUP)
    id resin11.488e780e.fdd7; Wed, 30 Jul 2008 01:11:54 -0700
MIME-Version: 1.0
Content-Type: text/html; charset=“UTF-8”
Message-Id: <20080730012754.6C854170@resin1 1.mta.everybody.net>
Date: Wed, 30 Aug 2010 01:11:54 -0700
From: “Joe Bloggs” <joe.bloggs@domain1.com>
Reply-To: <joe.bloggs@domain1.com>
To: “Jane Doe” <jane.doe@domain2.com>
Subject: Re: Your husband Jim
Content-Transfer-Encoding: base64
Return-Path: joe.bloggs@domain1.com
```

Email message headers also include information about the intended recipient 140, including the email address of the intended recipient 140 (in this case jane.doe@domain2.com).

The communication analyser 180 determines some or all of the parts of the header that relate to the sender 120 (that is, sender attributes) and the intended recipient 140 (that is, recipient attributes). At least two sender attributes are determined, one of which is preferably a communications address in the form of an email address. The communications address may also be the network address of the sending device 40, such as an Internet Protocol (IP) address if the sending device is connected to an IP network. In order to uniquely identify the sender 120, the sender attributes which are determined preferably include both the email address and network (e.g. IP) address of the sender 120.

The attributes determined by the communication analyser 180 may include attributes not contained within the communication but are derivable from the communication. For example, where the IP network domain of the sender 120 is not present in the stored part of the electronic communication but the IP address of the sender 120 can be identified, the network domain of the sender 120 may be determined by querying a database which matches IP addresses to domains. This process is known as a Reverse IP domain lookup. Similarly, the country from which the communication is being transmitted may be determined from the IP address of the sender.

The at least two sender attributes (such as the sender's email address and IP address) and the recipient attributes are sent from the communication analyser 180 to a database manager 30, which creates at least one data record associating the sender attributes with the recipient attributes and stores the data record in a database 50. A single data record may be created containing information identifying all of the sender attributes and recipient attributes, or multiple records may be created, each associating a subset of sender attributes with a subset of recipient attributes. For example, where the communication analyser 180 identifies the email address, IP address, country and network domain, the database manager 30 creates data records associating:
(i) the sender's IP & email address with the recipient's email address;
(ii) the sender's country & email address with the recipient's email address;
(iii) the sender's network domain & email address with the recipient's email address;
(iv) the sender's IP & email address with the recipient's domain (determined from the recipient's email address);
(v) the sender's country & email address with the recipient's domain; and
(vi) the sender's network domain & email address with the recipient's domain.

Each data record has a score, which at least reflects that the sender 120 has attempted to send an email to the intended recipient 140. Accordingly, each record may have a default score of 2. The score in each record may also be determined by an analysis by the communication analyser 180 of the contents of the communication. For example, if the communication contains a phishing attempt (an attempt to fraudulently obtain personal information as a first step of identity theft), a computer virus, or any other kind of malware, the score may be −2. If the communication contains both a virus and a phishing attempt, the score may be −4.

The data record may contain more than one type of score. For example, each record may have a first score that reflects whether the communication contains a virus, and may have a second score that reflects whether the communication contains a phishing attempt.

Where the database 50 contains information about the sender 120 or intended recipient 140, this information may be used to modify a data record's score. For example, if information in the database 50 records that the sender 120 has responded to a challenge (that is, has been asked by email to confirm his or her desire to communicate with the intended recipient 140, and has responded, indicating that he or she is human and not a machine configured to send bulk email), records including attributes of that sender 120 may have higher scores.

The data records in the database 50 provide information about the relationship between the sender 120 and the intended recipient 140. The scores in the data records may be used to determine a level of trust between the sender 120 and the intended recipient 140. An overall score may be calculated from relevant records. A high overall score will suggest that the relationship is a trusted one, and that consequently the communication is likely to have been solicited, or be desired, by the intended recipient 140. Conversely, a low overall score will suggest that the relationship is an untrusted one, and that consequently the communication is likely to be unsolicited, or unwanted by the intended recipient 140.

As indicated above, the database manager 30 may be configured to create one or more data records for each set of attributes it receives from the communication analyser 180, each set corresponding to a single communication from the sender 120. Alternatively, the database manager 30 may be configured to maintain a single record for each relationship, each relationship being defined by a tuple (<sender attribute 1>, <sender attribute 2>, <recipient attribute>) as exemplified above. Each data record contains at least the tuple and a score. This score may be a likelihood score representing the estimated likelihood that an electronic communication from the sender to the intended recipient is unwanted by the intended recipient.

Where a set of attributes is received from the communication analyser 180, the database manager 30 first checks the database 50 to determine whether the relationship defined by the attributes is the subject of a data record. If it is not, a data record is created associating the at least two sender attributes and at least one recipient attribute. However, if the database 50 contains an existing data record associating the at least two sender attributes and at least one recipient attribute, instead of creating a new record, the database manager 30 modifies the score in the existing data record based on information it receives from the communication analyser 180. The nature of this modification may depend on the contents or nature of the email (e.g. does it carry a virus? If so, the score will be reduced) or information known about the sender 120 or intended recipient 140 (have they successfully passed a challenge as described above? If so, the score will be increased).

A single communication intercepted by the communication transfer component 160 may result in the creation or modification of multiple records, or may cause only a single record relating to the relationship between the sender 120 and intended recipient 140 to be created or modified.

As indicated above, each data record contains at least two sender attributes. The use of a single attribute, such as the sender's email address, reduces the reliability of the database as it is fairly easy to “spoof” an email address (that is, to send an email appearing to originate from an email address belonging to someone other than the sender). This would allow unscrupulous email senders to rely upon, or decrease the scores of, relationships between a sender 120 and an intended recipient 140 by using the email address of the sender 120. However, it is much more difficult to impersonate a sender 120 where the sender is defined in the database using two attributes, for example, both an email address and an Internet Protocol address.

The system also includes a processor 70 in communication with the communications transfer component 160 and database manager 30. Where an electronic communication has been intercepted by the communication transfer component 160, the database manager 30 reports the scores of the relevant data records to the processor 70, to enable the processor 70 to instruct the communications transfer component 160 to transmit the electronic communication to the intended recipient 140, delete the electronic communication, or take some other action.

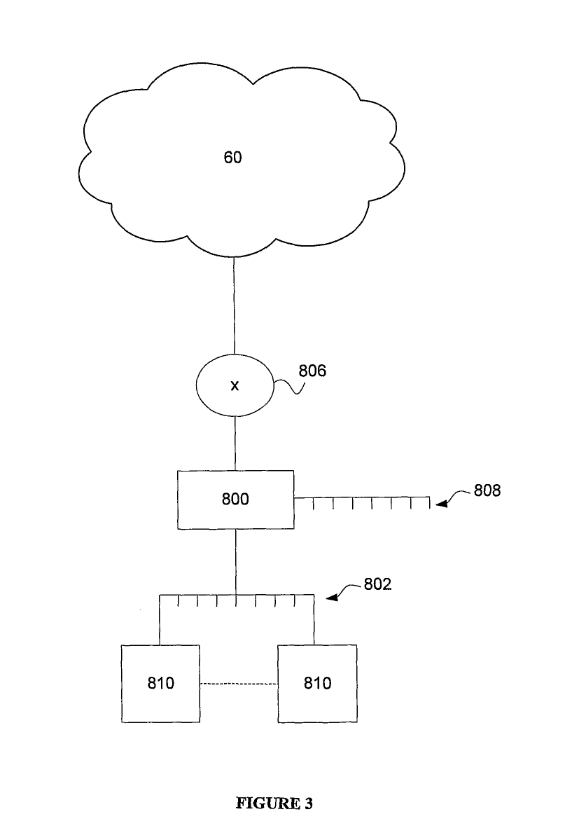

A method executed by the electronic communication control system 10 for generating a likelihood score representing the estimated likelihood that an electronic communication from a sender 120 to an intended recipient 140 is unsolicited or unwanted by the intended recipient 140 will now be described with reference to FIG. 3.

At step 400 the sender 120 sends an email addressed to the intended recipient 140. The email is intercepted by the communications transfer component 160 (step 420), and part or all of the email is copied and made available to the communication analyser 180 (step 440). The communication analyser 180 parses the email header to obtain the sender's communications address (in the form of an email address), the sender's network address (in the form of an IP address) and the intended recipient's communications address (in the form of an email address) (step 460). The sender's email address is a primary attribute of the sender 120, the sender's network address is an additional attribute of the sender 120, and the intended recipient's email address is a primary attribute of the intended recipient 140.

The communication analyser 180 uses the sender's IP address to determine the sender's IP network domain, and isolates the domain of the intended recipient's email address (step 480). The communication analyser 180 also determines whether the email contains a virus or other malware, or contains a phishing scam, by analysing at least part of the content of the email (step 500).

The communications analyser transmits the primary and additional sender attributes, the primary intended recipient attribute and the results of its content analysis to the database manager (step 520). If the database 50 contains records regarding the reputation of the sender 120 or intended recipient 140 (including whether they have responded to a challenge as outlined above), this information, along with information received from the communication analyser 180 as a result of its content analysis, is sent to the processor 70 where it is used to generate a score for the communication (step 540).

The database manager 30 creates a record having the primary and additional sender attributes and the primary intended recipient attribute. The database manager 30 may also create a record associating the sender's IP network domain with the domain of the intended recipient's email address. Each of these records is given a score which is either the same score as that generated in step 540, or is calculated by the processor 70 from the score generated in step 540 (step 560).

Where a communication has more than one intended recipient 140, database records are created associating each participant to the communication. For example, if Joe Bloggs sends an email to his daughter Jane Doe and son-in-law Jim Doe, data records containing the following relationships would be created:

<joe.bloggs@domain1.com, 207.221.56.1>,<jane.doe@domain2.com>, 2
<joe.bloggs@domain1.com, 207.221.56.1>,<jim.doe@domain3.com>, 2
<jane.doe@domain2.com><jim.doe@domain3.com>, 1

The database manager 30 may create additional records associating only the network domains involved in the communication:

<domain1.com>,<domain2.com>, 2
<domain1.com>, <domain3.com>, 2
<domain2.com>, <domain3.com>, 1

The processor 70 receives from the database manager 30 the records created by the database manager 30 in step 560, and uses those records to retrieve from the database 50 other records containing the sender's primary attribute (e.g. email address), the sender's secondary attribute (e.g. IP address) and the recipient's primary attribute (e.g. email address). The total scores for each of these retrieved records are used to determine a likelihood score. The processor 70 also retrieves from the database manager 30 records in the database 50 that relate to communications between at least one communication participant having the same attribute as the sender and another communication participant having the same attribute as the receiver (for example, records that relate to communications between a sender having the same network domain as the sender 120 and a recipient having the same network domain as the intended recipient 140) (step 600).

Using the example given above, if Jim Doe was to send an email to Jane Doe, this email would be intercepted by the communication transfer component 160, primary and secondary attributes would be derived by the communication analyser 180, and the database manager 30 would create records such as:

<jane.doe@domain2.com, 28.112.244.200>, <jim.doe@domain3.com>, 2
<domain2.com>, <domain3.com>, 2

These records are sent to the processor 70 by the database manager 30 (step 580). The processor 70 would then query the database 50 using the database manager 30 to obtain records containing jane.doe@domain2.com and jim.doe@domain3.com, as well as records containing domain2.com and domain3.com (step 600). It would therefore retrieve the relevant records stored in the database as a result of Joe Blogg's email to Jane Doe, namely:

<jane.doe@domain2.com><jim.doe@domain3.com>, 1
<domain2.com>, <domain3.com>, 1

As the first record does not contain an IP address for either Jane Doe or Jim Doe, it may have been the result of a fraudulent email. Accordingly, it is not given much weight in generating the likelihood score data representing the estimated likelihood that the email from Jim Doe was unsolicited or unwanted by Jane Doe. Similarly, the relationship between domain2.com and domain3.com is quite general, and it is also not given as much weight. The processor 70 generates score data for the email from Jim Doe to Jane Doe (step 620) which may represent the total value of the score data for the records just created by the database manager (i.e. a score of four), plus the weighted average of the two historical records retrieved from the database (an addition of 0.5 for each record) making a total score value of five, this being the likelihood score. This is compared (step 640) to a threshold score of 4, the threshold score in this case being the score taking into account the information from the records just created by the database manager 30. The likelihood score value for the communication is greater than the threshold score value, suggesting that there is some level of trust between Jim Doe and Jane Doe (based on the historical records generated as a result of a communication from Joe Bloggs to both Jim Doe and Jane Doe).

If the likelihood score for the communication is greater or equal to the threshold (in this case, 4), the communication is transmitted to the intended recipient 140 (step 680). However, if the likelihood score is less than 4, the communication is classed as unwanted or unsolicited, and is processed as SPAM (step 660). SPAM processing may involve tagging the communication as SPAM before transmitting it to the recipient, storing it in a SPAM folder, redirecting the communication to a predetermined communication address, challenging the sender as described above, or deleting the communication.

Any communications containing known SPAM content may be immediately blocked by the communication transfer component 160 operating under instructions from the communication analyser 180, and as a result data records with very low or negative scores may be created by the database manager 30 for storage in database 50.

The electronic communication control system 10 has particular applicability when implemented as a security server system 800, as illustrated in FIG. 4. The security server system 800 provides an Internet threat protection appliance to protect a local area network (LAN) 802 of an entity from a wide variety of Internet threats. The threats include viruses, worms, trojans, phishing, spyware, spam and undesirable content, and any other form of unwanted code, traffic or activity relevant to the LAN 802. The security server system 800 is connected directly to an external communications network 60, such as the Internet, by a router 806, thereby being positioned between the LAN 802 and the Internet 60. The LAN 802 connects a number of terminals 810 of the network 802. The terminals 810 are computer devices, such personal computers or telephones, capable of handling network traffic and messages, such as email and HTTP requests and responses. The security server system 800 may also provide support for a demilitarised zone (DMZ) 808 and, in alternative embodiments, the system 800 may include a number of machines. The system 800 can, for example, be one of the threat protection appliances produced by Network Box Corporation. The network architecture in which the security server system 800 is used can vary considerably. For example, a number of LANs or a wide area network (WAN) may be protected by one server system 800, or the system 800 may support more than one DMZ.

Initially the server system 800 may be configured to operate in “learning mode”. In this mode, all emails are sent to the intended recipient 140, and the database 50 is populated with data records from email transmitted through the communication transfer component 160 of the system 800. Data records generated as a result of communications transmitted from a sender 120 connected to the LAN 802 are given a higher score than data records generated as a result of incoming messages (that is, messages from outside the LAN directed to intended recipients 140 connected to the LAN), on the assumption that users of the LAN 802 are less likely to send than receive unsolicited or unwanted communications. In other words, it is unlikely that a user of the LAN 802 will send email that could be considered SPAM, but this assumption does not hold true for email messages directed to users of the LAN 802.

As indicated above, in the “learning mode” the communication transfer component 160 of the system 800 transmits all messages to their intended recipient 140, regardless of whether or not the recipient is a user of the LAN 802.

After an initial learning period, the server system 800 may be configured to operate in “enforcement mode”. In this mode, messages directed to users of the LAN are intercepted by communication transfer component 160, and the sender and intended recipient attributes are used to query the database 30 for records of previous electronic communications between participants at least one of which has the same primary and secondary attributes as the sender 120 and at least another of which has the same primary attribute as the intended recipient 140.

The scores of the records identified as a result of the query enable the calculation of a likelihood score representing the estimated likelihood that the electronic communication from the sender 120 to the intended recipient 140 is unsolicited or unwanted by the intended recipient 140 as further described above.

Where the likelihood score does not meet a threshold, the communication may not be sent to the intended recipient 140. Instead, the intended recipient 140 may be notified of the attempted communication and/or the intended sender may be challenged as further described above, or the communication may simply be dropped. Alternatively, the message may be sent filtered or tagged indicating it has been determined to be unwanted.

The data records retrieved by the processor 70 are not filtered by the direction of the communication, but direction is a factor in determining the weight to be given to the score in the data records when calculating the likelihood score. That is, a record relating to a communication from Joe Bloggs to Jane Doe will be retrieved when assessing a communication from Jane Doe to Joe Bloggs, but the score associated with this data record may be given a higher weight when calculating the likelihood score than a score associated with previous records recording communications from Jane Doe to Joe Bloggs.

As discussed above, the use of both a primary sender attribute and an additional sender attribute (for example an email address and an IP address) improves the integrity of the database 50 as it reduces the impact of records created as a result of a spoofed or faked email addresses. While records containing only email addresses may be created by the database manager 30, these records are given lower weight when calculating the likelihood score than records containing an additional sender attribute.

The system 10, 800 has been described above as comprising a number of elements including a communication transfer component 160, a communication analyser 180, a database manager 30 and a database 50. These need not be individual hardware devices, and each of them may be implemented as computer program code instructions stored in non-volatile memory (eg a hard disc or optical media) and executed by a computer based on an IA-32 or AMD64 architecture (such as personal computers produced by Lenovo Corporation or Apple Inc.), with central processing units (i.e. processors) supported by at least memory (e.g. RAM) and communications hardware (such as network interfaces). Alternatively, it will be apparent that at least parts of the steps and processes performed by these components may be implemented in dedicated hardware, such as FPGAs or ASICs, to improve data processing speed.

In addition, each component may be physically proximate, or geographically spread over a large distance and connected by a communication network, e.g. a LAN or WAN. One or more components may implemented using a single piece of hardware. For example, the database 30 and database manager 50 may be implemented as computer program code instructions executing on dedicated database hardware.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Many modifications will be apparent to those skilled in the art without departing from the spirit or scope of the present invention.

1. An electronic communication control system comprising:
a communication transfer component configured to temporarily store at least part of an electronic communication from a sender to an intended recipient;
a communication analyser associated with the communication transfer component and configured to analyse the stored part of the electronic communication and determine at least two sender attributes of the sender and at least one intended recipient attribute of the intended recipient;
a database configured to store data records having a score and being associated with at least two sender attributes and an intended recipient attribute; and
a database manager in communication with the communication analyser and configured to create a data record in the database associating the sender attributes with the intended recipient attribute and having a score based at least in part on information received from the message analyser.

2. A system as claimed in claim 1 wherein the database manager is configured to:
create a data record in the database associating the sender attributes with the intended recipient attribute and having a score based on information received from the communication analyser if such a data record does not exist in the database; and
modify the score of any data records in the database associated with the sender attributes and intended recipient attribute based on information received from the communication analyser if such data records exists in the database.

3. A system as claimed in claim 1 wherein the communication transfer component is configured to selectively transmit the electronic communication to the intended recipient, the system further including:
a processor in communication with the communication transfer component and database manager and configured to control whether the electronic communication is transmitted to the intended recipient by the communication transfer component based at least in part on the score of one or more data records associating the sender attributes and the intended recipient attribute.

4. A system as claimed in claim 1 wherein the at least two sender attributes include a communication address.

5. A system as claimed in claim 4 wherein the communication address is an electronic mail address.

6. A system as claimed in claim 4 wherein the communication address is an Internet Protocol address;

7. A system as claimed in claim 1 wherein the at least two sender attributes include an email address and an Internet Protocol address.

8. A system as claimed in claim 1 wherein the at least two sender attributes include a network domain identified as a result of a database query using an Internet Protocol address.

9. A system as claimed in claim 1 wherein the at least two sender attributes include a country.

10. A system as claimed in claim 1 wherein the intended recipient attribute is an electronic mail address.

11. A method, performed by an electronic communication control system, comprising:
parsing an electronic communication from a sender to an intended recipient;
storing a primary attribute and at least one additional attribute associated with the sender, and a primary attribute associated with the intended recipient;
generating a likelihood score, representing the estimated likelihood the electronic communication is unwanted by the intended recipient, using a stored data for electronic communications between at least one communication participant having the same primary and additional attributes as the sender and at least one other communication participant having the same primary attribute as the intended recipient; and
processing said electronic communication based on said likelihood score.

12. A method as claimed in claim 11 wherein generating said likelihood score includes using stored data for electronic communications between at least one participant having the same communications address and additional attribute as the sender, and at least one other participant having the same primary attribute as intended recipient.

13. A method as claimed in claim 12 wherein generating the likelihood score includes using stored data for electronic communications between at least one participant having the same communications address and additional attribute as the sender, and at least one other participant having the same communications address as the intended recipient.

14. A method as claimed in claim 11 wherein the additional attribute is a network address.

15. A method as claimed in claim 14 wherein the additional attribute is an Internet Protocol address.

16. A method as claimed in claim 14 wherein the additional attribute is a network domain.

17. A method as claimed in claim 11 wherein the additional attribute is a country.

18. A method as claimed in claim 11 wherein the communications address is an electronic mail address.

19. A method, performed by an electronic communication control system, comprising:
extracting from an electronic communication sent by a sender to an intended recipient, primary attributes of the sender and recipient, and at least one additional attribute of the sender; and
maintaining at least one data record having a score and associating the primary and additional attributes of the sender and the primary attribute of the intended recipient, said score representing a relationship between said sender and said recipient.

20. A method as claimed in claim 19 wherein the maintaining includes modifying the score of a data record associated with the primary and additional attributes of the sender and the primary attribute of the intended recipient if such a data record exists in the database.

21. A method as claimed in claim 19 wherein the step of extracting primary attributes includes the step of extracting a communication address.

22. A method as claimed in claim 21 wherein extracting primary attributes includes the step of extracting an email address.

23. A method as claimed in claim 19 wherein extracting at least one additional attribute includes extracting a sender network address.

24. A method as claimed in claim 19 wherein extracting at least one additional attribute includes the step of extracting an Internet Protocol address.

25. A method as claimed in claim 19 wherein extracting at least one additional attribute includes the step of extracting a network domain.

26. A method as claimed in claim 19, including determining processing of said electronic communication as unwanted by the intended recipient or otherwise based on said score.

27. An electronic communication control system comprising:
a communication analyser configured to analyse an electronic communication and determine a sender attribute and an intended recipient attribute; and
a relationship database configured to store a data record having a relationship score associated with the sender attribute and the intended recipient attribute; and
a processor in communication with the communication analyser and database and configured to control whether the electronic communication is processed as unwanted by the intended recipient.

28. A system as claimed in claim 27, comprising a database analyser configured to:
create a data record in the database containing data identifying the sender attribute and the intended recipient attribute, and a score based on information received from the communication analyser, if such a data record does not exist in the database; and
modify the score of any data records in the database containing data identifying the sender attribute and intended recipient attribute based on information received from the communication analyser if such data records exists in the database.

29. A system as claimed in claim 27, wherein the communication analyser is configured to determine more than one sender attribute.

30. A system as claimed in claim 27 wherein the sender attribute relates to the location of the sender and the recipient attribute relates to the location of the recipient.

31. A system as claimed in claim 27 wherein at least one of said sender attribute and recipient attribute is an Internet Protocol address.

32. A system as claimed in claim 27 wherein at least one of said sender attribute and the recipient attribute is a network domain.

33. A system as claimed in claim 27 wherein at least one of said sender attribute and the recipient attribute represents a country.
